(19) United States
(12) Patent Application Publication
(10) Pub. No.: US 2003/0056359 A1
(43) Pub. Date: Mar. 27, 2003

(54) Assembly device and method for assembling housing

(75) Inventors: Richad H, Dung Guan Hsien (CN); Mei Xuzhi, Dung Guan Hsien (CN)

Correspondence Address: Richard P. Beng, Esq., c/o LADAS & PARRY, Suite 2100, 5670 Wilshire Boulevard, Los Angeles, CA, 90036-5679, US

(73) Assignee: Loyalty Founder Enterprise Co., Ltd.

(21) Appl. No.: 10/124,163

(22) Filed: Apr. 16, 2002

(30) Foreign Application Priority Data
Sep. 27, 2001 (TW) 90123957

(51) Int. Cl. B23P 11/00

(52) U.S. Cl. 29/505

(57) ABSTRACT

An assembly device and method for assembling a housing having a first component and a second component. The second component is fixed onto the first component by the assembly device such that the surfaces of the housing are not scraped. The assembly device comprises a holding portion and a recess disposed on the holding portion for receiving the second positioning portion and fixing the second component onto the first component. The assembly method comprises the steps of engaging the assembly device with the second positioning portion and rotating the assembly device to bend the second positioning portion such that the second component is fixed onto the first component.

### BACKGROUND OF THE INVENTION

1. Field of the Invention

The present invention relates to an assembly device and method, and in particular to an assembly device and method for assembling a housing used for a computer.

2. Description of the Related Art

As the surfaces of a computer housing are coated or electroplated with metal materials, improper assembly tools such as pliers and wrenches often cause scrapes on the surfaces while bending the protruding portions of the computer housing.

Consequently, an object of the invention is to overcome the aforementioned problem and provide a reliable assembly device to assemble the computer housing.

### SUMMARY OF THE INVENTION

An object of the invention is to provide an assembly device for assembling a housing having a first component and a second component. The first component has a first positioning portion and a second positioning portion protruding from the first positioning portion. The second component has a third positioning portion and a fourth positioning portion. The third positioning portion is engaged with the first positioning portion and the fourth positioning portion is engaged with the second positioning portion. The assembly device comprises a holding portion and a recess disposed on the holding portion for receiving the second positioning portion and fixing the second component onto the first component.

Another object of the invention is to provide an assembly method for assembling a housing having a first component and a second component. The first component has a first positioning portion and a second positioning portion protruding from the first positioning portion. The second component has a third positioning portion and a fourth positioning portion. The third positioning portion is engaged with the first positioning portion and the fourth positioning portion is engaged with the second positioning portion. The assembly method comprises the steps of engaging an assembly device with the second positioning portion and rotating the assembly device to bend the second positioning portion such that the second component is fixed onto the first component.

A detailed description will be given by the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A shows a first component (1) and a second component (2) of a housing (C);

FIG. 1B shows the second component (2) joined to the first component (1);

FIG. 2A shows that an assembly device (J) is to position the first component (1) and the second component (2);

FIG. 2B shows the second component (2) fixed onto the first component (1) by the assembly device (J); and

FIG. 3 shows the assembled housing (C).

### DETAILED DESCRIPTION OF THE PREFERRED EMBODIMENT

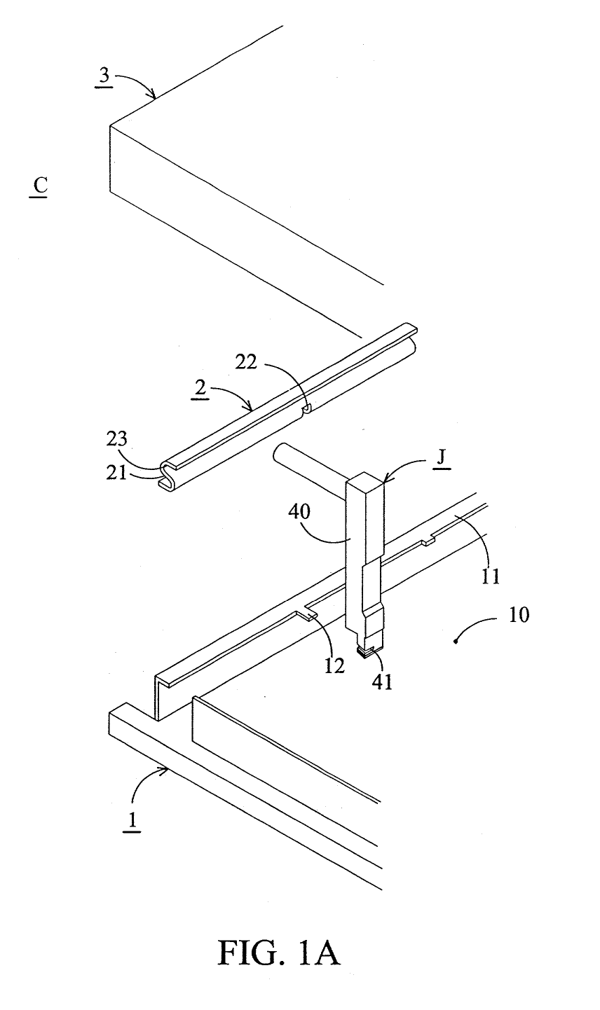

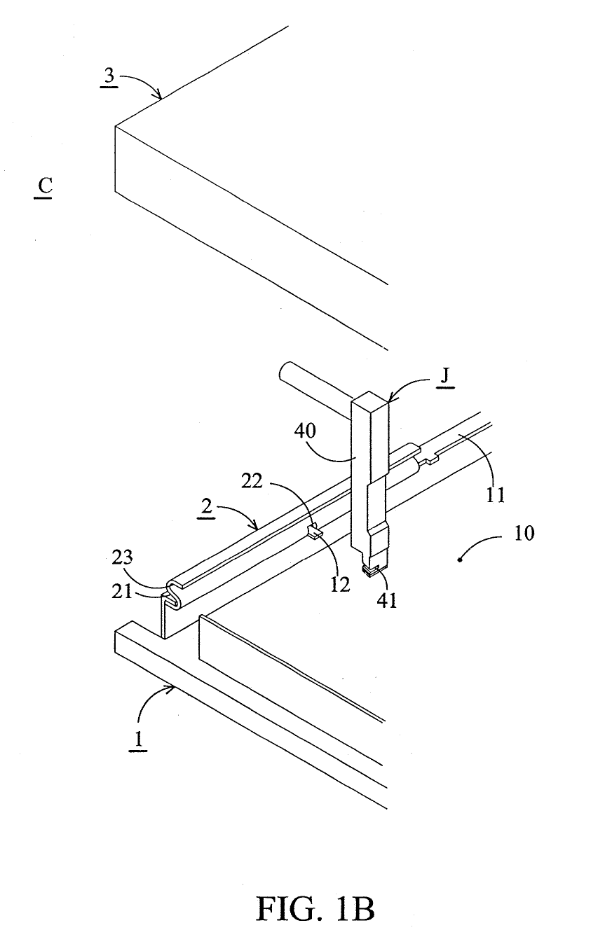

Referring to FIG. 1A and FIG. 1B, the housing C is an outer casing of a computer and comprises a first component 1, a second component 2 and a cover 3. The first component 1 serves as a base of the housing C and is used for mounting circuit devices such as a main board and storage devices including hard disk drives, floppy drives and a CD-ROM. The second component 2 is an intermediate component disposed on the first component 1. The cover 3 is placed on the first component 1 including the second component 2 so as to embrace the plural devices disposed on the first component 1.

The first component 1 comprises a base 10, a first positioning portion 11 and a second positioning portion 12. The first positioning portion 11 is a continuous flange formed on the base 10 and the second positioning portion 12 is a protrusion formed integrally on the first positioning portion 11.

The second component 2 is a longitudinal sheet material and has an S-shaped cross section. The second component 2 comprises a third positioning portion 21, a fourth positioning portion 22 and a first engaging portion 23. The fourth positioning portion 22 is an opening formed on the third positioning portion 21. The third positioning portion 21 is engaged with the first positioning portion 11 and the fourth positioning portioning 22 is engaged with the second positioning portion 12 (as shown in FIG. 1B).

The assembly device J comprises a holding portion 40 and a recess 41. The shape of the recess 41 depends on that of the second positioning portion 12 of the first component 1.

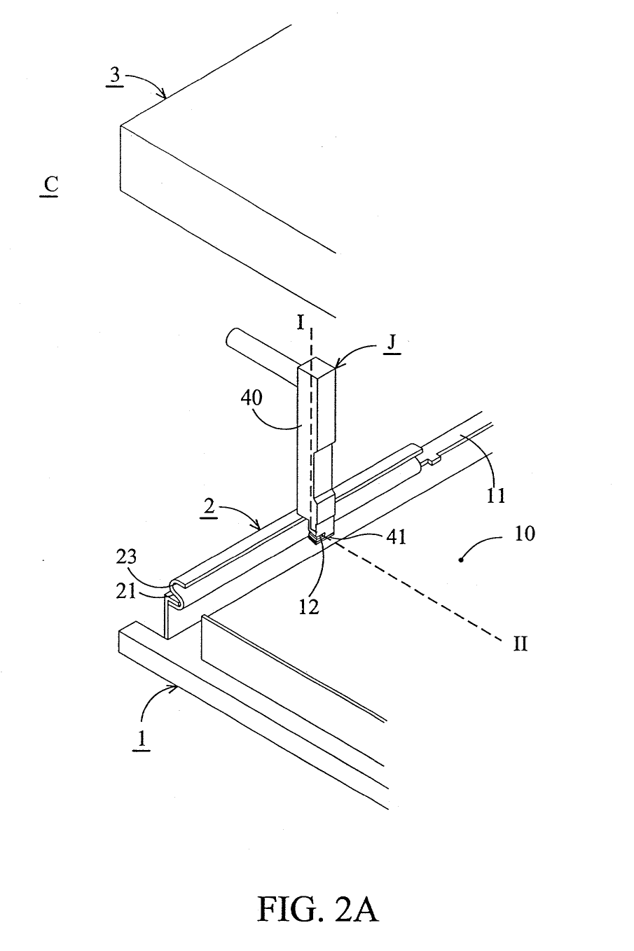

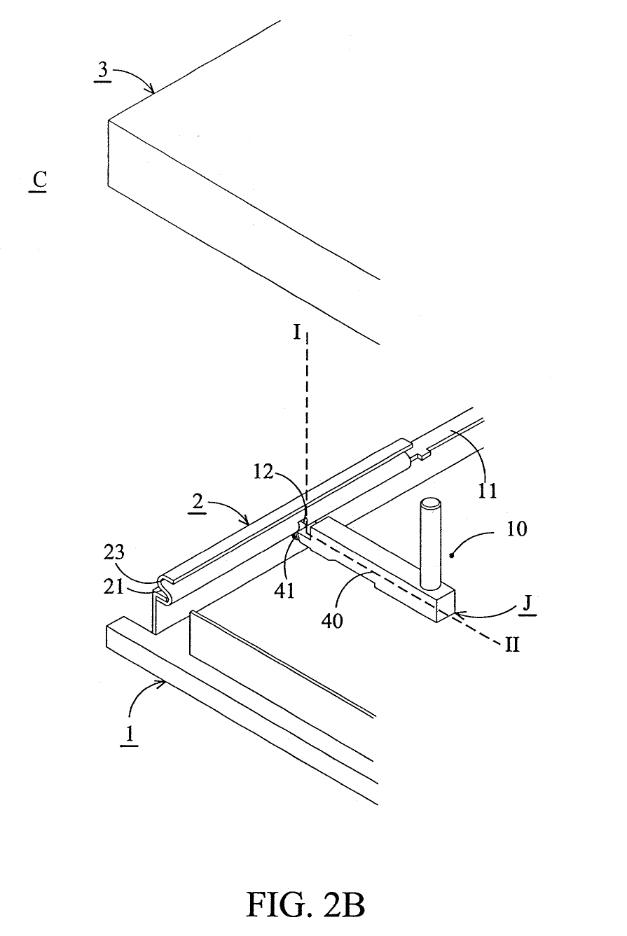

Referring to FIG. 2A, when the second component 2 is to be fixed onto the first component 1 by the assembly device J. the recess 41 on the holding portion 40 receives the second positioning portion 12. Referring to FIG. 2B, when the assembly device J rotates from a first position I to a second position II, the second positioning portion 12 is bent downward such that the second component 2 is tightly fixed onto the first component 1.

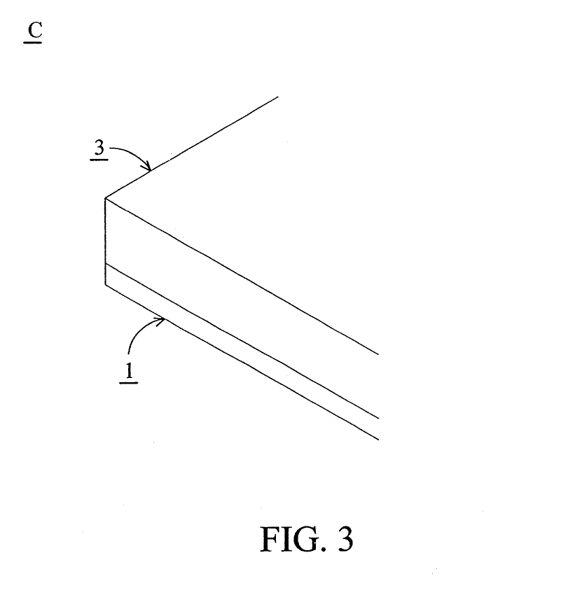

Subsequently, as shown in FIG. 3, the cover 3 is closed to the first component 1 by engaging a second engaging portion (not shown) disposed in the cover 3 with the first engaging portion 23 to form the assembled housing C.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly method for assembling a housing having a first component and a second component, the first component having a first positioning portion and a second positioning portion protruding from the first positioning portion, the second component having a third positioning portion and a fourth positioning portion, the third positioning portion engaged with the first positioning portion, the fourth positioning portion engaged with the second positioning portion, comprising the steps of:
engaging an assembly device with the second positioning portion; and
rotating the assembly device to bend the second positioning portion such that the second component is fixed onto the first component.

2. The assembly method as claimed in claim 1, wherein the assembly device further includes a recess for receiving the second positioning portion.

3. The assembly method as claimed in claim 1, wherein the first positioning portion is a flange.

4. The assembly method as claimed in claim 1, wherein the second positioning portion is a protrusion formed integrally on the first positioning portion.

5. The assembly method as claimed in claim 1, wherein the second component is a sheet material.

6. The assembly method as claimed in claim 1, wherein the fourth positioning portion is an opening.

7. An assembly device for assembling a housing having a first component and a second component, the first component having a first positioning portion and a second positioning portion protruded from the first positioning portion, the second component having a third positioning portion and a fourth positioning portion, the third positioning portion engaged with the first positioning portion, the fourth positioning portion engaged with the second positioning portion, comprising:
a holding portion; and
a recess disposed on the holding portion for receiving the second positioning portion and fixing the second component onto the first component.

8. The assembly device as claimed in claim 7, wherein the first positioning portion is a flange.

9. The assembly device as claimed in claim 7, wherein the second positioning portion is a protrusion formed integrally on the first positioning portion.

10. The assembly device as claimed in claim 7, wherein the second component is a sheet material.

11. The assembly device as claimed in claim 7, wherein the fourth positioning portion is an opening.
